(19) United States
(12) Patent Application Publication
(10) Pub. No.: US 2026/0301475 A1
(43) Pub. Date: Oct. 1, 2026

(54) DISPLAY CONTROL SYSTEM FOR WORK MACHINE

(71) Applicant: KOMATSU LTD., Tokyo (JP)

(72) Inventors: Minami Sugimura, Tokyo (JP); Norihiro Kobayashi, Tokyo (JP)

(73) Assignee: KOMATSU LTD., Tokyo (JP)

(21) Appl. No.: 19/481,219

(22) PCT Filed: Jun. 28, 2024
(86) PCT No.: PCT/JP2024/023574

§ 371 Date: Nov. 4, 2025

(30) Foreign Application Priority Data
Jun. 29, 2023 (JP) 2023-106844

(51) Int. Cl. G07C 5/00; B60L 58/12; E02F 3/32; E02F 9/26

(52) U.S. Cl. CPC G07C 5/004; B60L 58/12; E02F 9/26; B60L 2200/40; E02F 3/32

(57) ABSTRACT

A time calculation unit calculates information regarding a remaining operating time of a work machine, based on a remaining level of a battery and the behavior of the work machine in a predetermined period. An output unit outputs a signal for displaying the information regarding the remaining operating time

### TECHNICAL FIELD

The present disclosure relates to a display control system for a work machine.

The present application claims priority based on Japanese Patent Application No. 2023-106844, filed Jun. 29, 2023, the content of which is incorporated herein by reference.

### BACKGROUND ART

In construction work in urban areas and the like, an electrically-driven work machine with zero emission and low noise may be used. The electrically-driven work machine does not include an engine or a fuel tank, but includes an electric motor that drives a hydraulic pump or the like, and an electric storage device such as a battery that supplies electric power to the electric motor. Such an electrically-driven work machine requires a time for charging as compared with an engine-driven work machine. Therefore, it is important for an operator to be aware of the remaining operating time of the electrically-driven work machine.

Patent Document 1 discloses a display device that is mounted on a work machine including an electric motor as a power source and displays a remaining battery level or a remaining operating time of a work vehicle.

### CITATION LIST

### Patent Literature

Patent Document 1: JP 2007-288894 A

### SUMMARY OF INVENTION

### Technical Problem

The power consumption of a work machine varies depending on the behavior of the work machine. Therefore, a remaining operating time calculated from a remaining battery level and the power consumption per predetermined unit time may deviate from an actual remaining operating time.

An object of the present disclosure is to provide a display control system for a work machine capable of appropriately presenting information regarding a remaining operating time.

### Solution to Problem

A display control system for a work machine according to an aspect of the present disclosure is a display control system for a work machine driven by a battery and includes a calculation unit that calculates information regarding a remaining operating time of the work machine based on a remaining level of the battery and a behavior of the work machine in a predetermined period, and an output unit that outputs a signal for displaying the information regarding the remaining operating time.

### Advantageous Effects of Invention

According to the above-described aspect, the display control system can appropriately present the information regarding the remaining operating time.

### BRIEF DESCRIPTION OF DRAWINGS

FIG. 1 is a schematic diagram illustrating a configuration of a display control system according to a first embodiment.

FIG. 2 is a diagram illustrating a configuration of a work machine according to the first embodiment.

FIG. 3 is a diagram illustrating an internal configuration of a cab according to the first embodiment.

FIG. 4 is a schematic block diagram illustrating a configuration of a work analysis device according to the first embodiment.

FIG. 5 is a flowchart illustrating a method of presenting a screen by the work analysis device according to the first embodiment.

FIG. 6 is a diagram illustrating an example of a display screen according to the first embodiment.

### DESCRIPTION OF EMBODIMENTS

### First Embodiment

### Overall Configuration

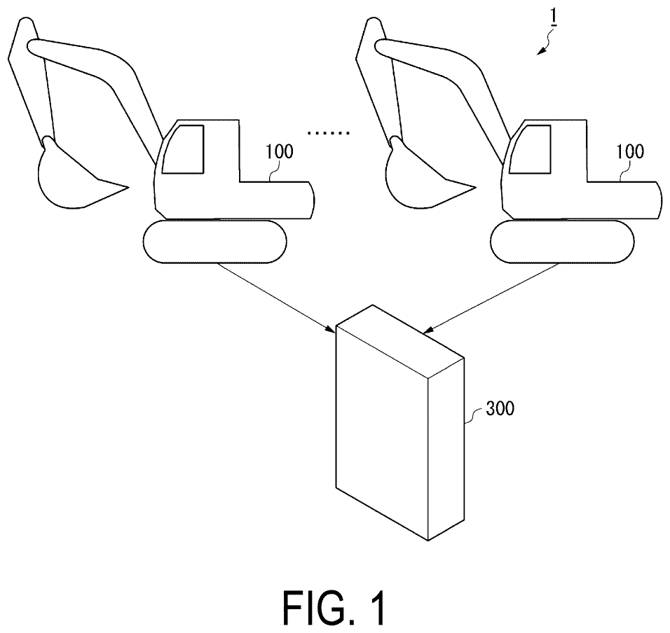

FIG. 1 is a schematic diagram illustrating a configuration of a display control system 1 according to the first embodiment. The display control system 1 includes a work machine 100 and a work analysis device 300. The work analysis device 300 analyzes a work of the work machine 100 and generates a screen for displaying information regarding a work history and a remaining operating time of the work machine. In the first embodiment, the information regarding the remaining operating time includes a remaining operating time and an end timing of an operable period. A user can recognize the remaining operating time of the work machine 100 by visually checking the screen output by the work analysis device 300.

The work machine 100 is a target of work analysis by the work analysis device 300. Examples of the work machine 100 include other work machines such as a hydraulic excavator and a wheel loader. In the first embodiment, an electrically-driven hydraulic excavator will be described as an example of the work machine 100. The work machine 100 is provided with a plurality of sensors, and information on a measurement value of each sensor is transmitted to the work analysis device 300.

### Work Machine 100

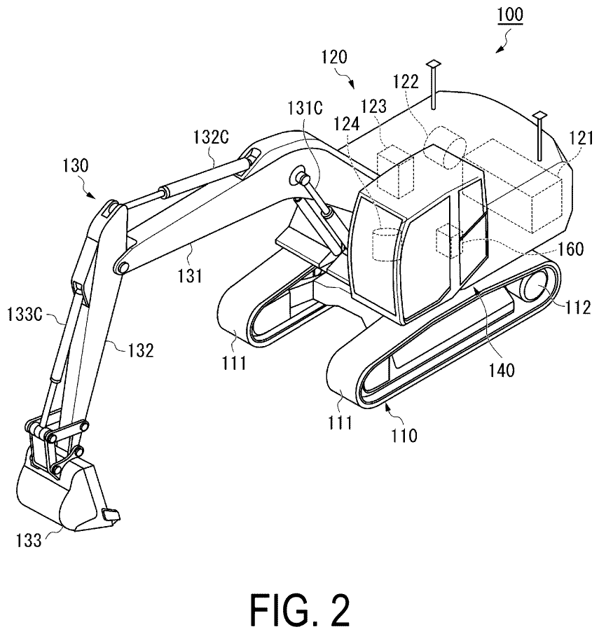

FIG. 2 is a diagram illustrating a configuration of the work machine 100 according to the first embodiment. The work machine 100 operates at a construction site, excavates a construction target such as earth and sand, and loads the construction target onto a loading platform such as a vessel of a loading target T such as a dump truck. Examples of the work machine 100 include a face shovel, a backhoe shovel, and a rope shovel. Further, the work machine 100 may be electrically driven or may be hydraulically driven. The work machine 100 according to the first embodiment is a backhoe shovel. The work machine 100 includes a traveling body 110, a revolving body 120, a work implement 130, and a cab 140. Examples of the loading target T include a dump truck and a hopper.

The traveling body 110 supports the work machine 100 such that the work machine 100 can travel. The traveling body 110 includes two endless tracks 111 provided on left and right sides and two travel motors 112 for driving the endless tracks 111. The traveling body 110 is an example of a support part.

The revolving body 120 is supported by the traveling body 110 so as to be revolvable about a revolution center.

The work implement 130 is driven by hydraulic pressure. The work implement 130 is supported at a front portion of the revolving body 120 so as to be drivable in an up-down direction.

The cab 140 is a space where an operator rides and operates the work machine 100. The cab 140 is provided in a left front portion of the revolving body 120.

Here, a portion of the revolving body 120 where the work implement 130 is attached is referred to as a front portion. Further, in the revolving body 120, with reference to the front portion, a portion on a side opposite to the front portion is referred to as a rear portion, a portion on the left side is referred to as a left portion, and a portion on the right side is referred to as a right portion.

### Configuration of Revolving Body 120

The revolving body 120 includes a battery 121, a hydraulic pump 122, a control valve 123, and a revolution motor 124.

The battery 121 is a power source that drives the hydraulic pump 122.

The hydraulic pump 122 is an electric pump driven by electric power supplied from the battery 121. The hydraulic pump 122 supplies hydraulic oil to actuators (a boom cylinder 131C, an arm cylinder 132C, a bucket cylinder 133C, the travel motors 112, and the revolution motor 124) via the control valve 123.

The control valve 123 controls a flow rate of the hydraulic oil supplied from the hydraulic pump 122.

The revolution motor 124 is driven by the hydraulic oil supplied from the hydraulic pump 122 via the control valve 123 and revolves the revolving body 120.

### Configuration of Work Implement 130

The work implement 130 includes a boom 131, an arm 132, a bucket 133 as a work tool, the boom cylinder 131C, the arm cylinder 132C, and the bucket cylinder 133C. Other examples of the work tool include distal end attachments such as a clamshell bucket, a tilt bucket, a tilt rotator bucket, a grapple, and a lifting magnet.

A base end portion of the boom 131 is rotatably attached to the revolving body 120 via a boom pin. In the work machine 100 illustrated in FIG. 1, the boom 131 is provided at a front center portion of the revolving body 120, but the position is not limited thereto, and the boom 131 may be attached offset in a left-right direction. In that case, the revolution center of the revolving body 120 is not located on an operation plane of the work implement 130.

The arm 132 couples the boom 131 and the bucket 133. A base end portion of the arm 132 is rotatably attached to a distal end portion of the boom 131 via an arm pin.

The bucket 133 is rotatably attached to a distal end portion of the arm 132 via a pin. The boom 131 and the arm 132 are members that support the bucket 133. The bucket 133 serves as a container for accommodating excavated earth and sand.

The boom cylinder 131C is a hydraulic cylinder for actuating the boom 131. A base end portion of the boom cylinder 131C is attached to the revolving body 120. A distal end portion of the boom cylinder 131C is attached to the boom 131.

The arm cylinder 132C is a hydraulic cylinder for driving the arm 132. A base end portion of the arm cylinder 132C is attached to the boom 131. A distal end portion of the arm cylinder 132C is attached to the arm 132.

The bucket cylinder 133C is a hydraulic cylinder for driving the bucket 133. A base end portion of the bucket cylinder 133C is attached to the arm 132. A distal end portion of the bucket cylinder 133C is attached to a link mechanism that turns the bucket 133.

### Configuration of Cab 140

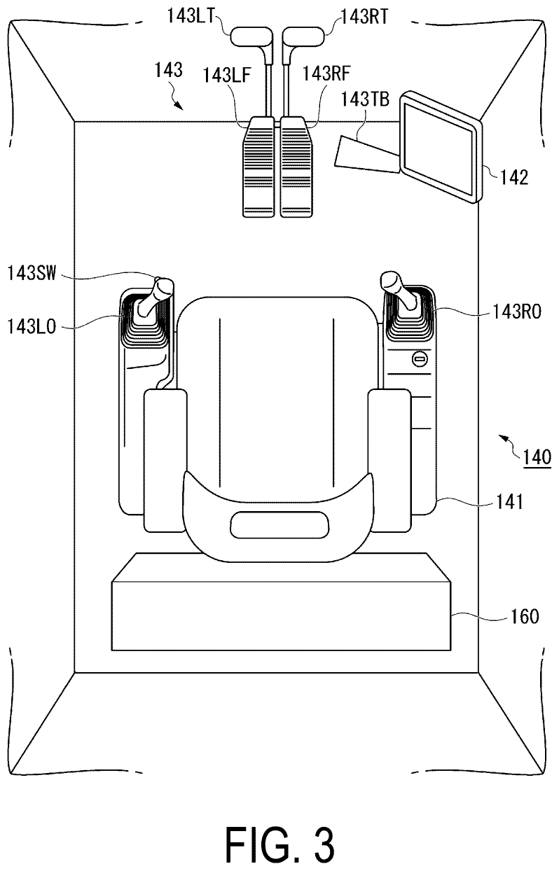

FIG. 3 is a diagram illustrating an internal configuration of the cab 140 according to the first embodiment.

An operator seat 141, an operation terminal 142, an operation device 143, and a control device 160 are provided in the cab 140. The operation terminal 142 is provided in the vicinity of the operator seat 141. The operation terminal 142 is a display device including a touch panel, for example. Further, the operation terminal 142 may include a display device such as an LCD.

The operation device 143 is a device for driving the traveling body 110, the revolving body 120, and the work implement 130 by manual operation by the operator. The operation device 143 includes a left operation lever 143LO, a right operation lever 143RO, a left foot pedal 143LF, a right foot pedal 143RF, a left travel lever 143LT, a right travel lever 143RT, and a revolution brake pedal 143TB.

The left operation lever 143LO is provided on the left side of the operator seat 141. The right operation lever 143RO is provided on the right side of the operator seat 141.

The left operation lever 143LO is an operation mechanism for performing a revolution operation of the revolving body 120 and an excavation/dumping operation of the arm 132. Specifically, when the operator of the work machine 100 tilts the left operation lever 143LO in a forward direction, the arm 132 performs the dumping operation. When the operator of the work machine 100 tilts the left operation lever 143LO in a rearward direction, the arm 132 performs the excavation operation. When the operator of the work machine 100 tilts the left operation lever 143LO in a rightward direction, the revolving body 120 revolves to the right. When the operator of the work machine 100 tilts the left operation lever 143LO in a leftward direction, the revolving body 120 revolves to the left. Note that, in another embodiment, the revolving body 120 may revolve to the right or the left when the left operation lever 143LO is tilted in a front-rear direction, and the arm 132 may perform the excavation operation or the dumping operation when the left operation lever 143LO is tilted in the left-right direction.

The right operation lever 143RO is an operation mechanism for performing the excavation/dumping operation of the bucket 133 and a raising/lowering operation of the boom 131. Specifically, when the operator of the work machine 100 tilts the right operation lever 143RO in the forward direction, the lowering operation of the boom 131 is performed. When the operator of the work machine 100 tilts the right operation lever 143RO in the rearward direction, the raising operation of the boom 131 is performed. When the operator of the work machine 100 tilts the right operation lever 143RO in the rightward direction, the dumping operation of the bucket 133 is performed. When the operator of the work machine 100 tilts the right operation lever 143RO in the leftward direction, the excavation operation of the bucket 133 is performed. Note that, in another embodiment, the bucket 133 may perform the dumping operation or the excavation operation when the right operation lever 143RO is tilted in the front-rear direction, and the boom 131 may perform the raising operation or the lowering operation when the right operation lever 143RO is tilted in the left-right direction.

The left foot pedal 143LF is disposed on the left side of a floor surface in front of the operator seat 141. The right foot pedal 143RF is disposed on the right side of the floor surface in front of the operator seat 141. The left travel lever 143LT is pivotally supported by the left foot pedal 143LF and is configured such that the tilting of the left travel lever 143LT and a depression of the left foot pedal 143LF are interlocked with each other. The right travel lever 143RT is pivotally supported by the right foot pedal 143RF and is configured such that the tilting of the right travel lever 143RT and a depression of the right foot pedal 143RF are interlocked with each other.

The left foot pedal 143LF and the left travel lever 143LT correspond to the rotational driving of a left-side crawler of the traveling body 110. Specifically, when the operator of the work machine 100 tilts the left foot pedal 143LF or the left travel lever 143LT in the forward direction, the left-side crawler rotates in the forward traveling direction. When the operator of the work machine 100 tilts the left foot pedal 143LF or the left travel lever 143LT in the rearward direction, the left-side crawler rotates in the rearward traveling direction.

The right foot pedal 143RF and the right travel lever 143RT correspond to the rotational driving of a right-side crawler of the traveling body 110. Specifically, when the operator of the work machine 100 tilts the right foot pedal 143RF or the right travel lever 143RT in the forward direction, the right-side crawler rotates in the forward traveling direction. When the operator of the work machine 100 tilts the right foot pedal 143RF or the right travel lever 143RT in the rearward direction, the right-side crawler rotates in the rearward traveling direction.

The control device 160 collects measurement data collected from the plurality of sensors included in the work machine 100 and operation amounts of the operation device 143, and stores the measurement data and the operation amounts in association with time stamps. The control device 160 transmits a time series of measurement data and operation amounts to the work analysis device 300. The control device 160 is a computer including a processor, a main memory, a storage, and an interface (all of these components are not illustrated). The storage of the control device 160 stores a data aggregation program. The processor of the control device 160 reads the data aggregation program from the storage, loads the data aggregation program into the main memory, and executes a process of collecting measurement data and operation amounts in accordance with the data aggregation program and transmitting the same. The control device 160 may be provided inside or outside the work machine 100.

The work machine 100 includes the plurality of sensors. Each of the sensors outputs a measurement value to the control device 160. The work machine 100 includes at least a power meter that measures the power consumption of the battery 121 and a battery level meter that measures the remaining level of the battery 121. The work machine 100 may include, as the sensors, a cylinder stroke sensor for determining the orientation of the work implement 130, a pressure sensor for determining the weight of the work implement 130, an IMU for measuring the revolution angle of the revolving body 120, and the like.

### Configuration of Work Analysis Device

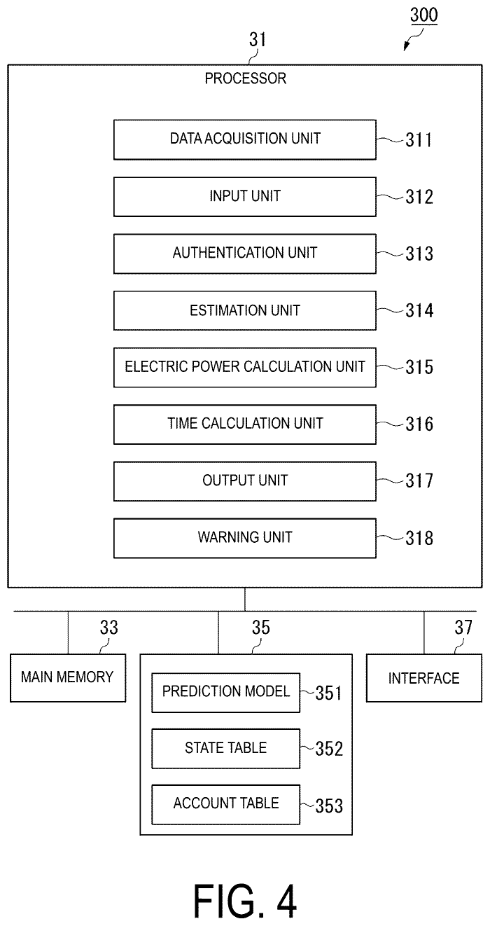

FIG. 4 is a schematic block diagram illustrating a configuration of the work analysis device according to the first embodiment.

The work analysis device 300 is a computer including a processor 31, a main memory 33, a storage 35, and an interface 37. The storage 35 stores a work analysis program. The processor 31 reads the work analysis program from the storage 35, loads the work analysis program into the main memory 33, and executes processing according to the work analysis program. Note that the work analysis device 300 according to the first embodiment is provided outside the work machine 100, but in another embodiment, a part or all of the functions of the work analysis device 300 may be provided inside the work machine 100.

Examples of the storage 35 include a semiconductor memory, a disk medium, and a tape medium. The storage 35 may be an internal medium directly connected to a common communication line of the work analysis device 300, or may be an external medium connected to the work analysis device 300 via the interface 37. The storage 35 is a non-transitory tangible storage medium.

The processor 31 includes a data acquisition unit 311, an input unit 312, an authentication unit 313, an estimation unit 314, an electric power calculation unit 315, a time calculation unit 316, an output unit 317, and a warning unit 318 by executing the work analysis program. The work analysis program stored in the storage 35 includes a prediction model 351. The prediction model is a learning model that has been trained by being input with a time series of measurement data and operation amounts so as to output a time series of work sections. The prediction model 351 is trained using, as a learning data set, a combination of the time series of measurement data and operation amounts and a time series of labels of work sections of the work machine 100 when the measurement data is collected. The prediction model may be, for example, a neural network model. In addition, in the storage 35, storage regions of a state table 352 that stores state data for each work machine 100 and an account table 353 that stores account data of users are secured.

The state table 352 stores a work machine ID, a time, a type of state data, and a value of the state data in association with each other. The account table 353 stores a user ID, a password, one or more work machine IDs for which viewing of state data is permitted, an analysis target period, and a threshold value of a remaining operating time in association with each other. The threshold value of the remaining operating time is used for warning the user of the remaining level of the battery 121.

The work analysis device 300 according to the first embodiment functions as a web server. That is, the work analysis device 300 receives a request message (HTTP request) from a display device operated by a user, executes predetermined processing, and outputs a response message for screen display.

The data acquisition unit 311 acquires a time series of state data indicating the state of the work machine 100 from the control device 160 of the work machine 100. That is, the data acquisition unit 311 acquires a plurality of combinations of a time stamp and state data. The state data may include a measurement value of each sensor of the work machine 100 and a value obtained by the control device 160 based on the measurement value. The data acquisition unit 311 stores the acquired time series of state data in the state table 352 of the storage 35 in association with the ID of the work machine 100.

The input unit 312 receives a request message from a user. The request message may include a value of a request parameter.

The authentication unit 313 performs a user authentication process. For example, the authentication unit 313 performs the authentication process by collating a user ID and a password indicated by a request parameter added to a request message with the data of the account table 353.

The estimation unit 314 obtains a time series of work sections based on a new time series of state data acquired by the data acquisition unit 311 and the prediction model 351 stored in the storage 35. For example, the estimation unit 314 acquires a time series of likelihood related to a work section in the following procedure. The estimation unit 314 acquires state data at a time point of determining a work from a time series of state data. Next, the estimation unit 314 acquires a time series of each work section based on the acquired state data.

The estimation unit 314 determines a unit work section and an element work section as a work section. The unit work is a work for performing one work purpose. The element work is a work indicating a series of operations or works which are elements constituting a unit work and are classified by purposes.

Examples of element work sections include “excavation”, “loaded revolving”, “unloading”, “unloaded revolving”, “waiting for unloading”, “loading platform pressing”, “compacting”, “push leveling”, “sweeping”, and the like. “Excavation” is a work of excavating and removing earth and sand, or rocks by the bucket 133.

“Loaded revolving” is a work of revolving the revolving body 120 while holding the removed earth and sand, or rocks in the bucket 133.

“Unloading” is a work of discharging the removed earth and sand, or rocks from the bucket 133 to a transport vehicle or a predetermined place.

“Unloaded revolving” is a work of revolving the revolving body 120 without earth and sand, or rocks in the bucket 133.

“Waiting for unloading” is a work of waiting for a transport vehicle for loading while holding the removed earth and sand, or rocks in the bucket 133.

“Loading platform pressing” is a work of pressing the earth and sand loaded on a loading platform of a transport vehicle from above with the bucket 133 to flatten the earth and sand.

“Compacting” is a work of pushing earth and sand into disturbed ground with the bucket 133 to shape and strengthen the ground.

“Push leveling” is a work of sweeping and leveling earth and sand with the bottom surface of the bucket 133.

“Sweeping” is a work of sweeping and leveling earth and sand with a side surface of the bucket 133.

Examples of unit work sections include “dump loading”, “load collection”, “traveling”, and “stopping”.

“Dump loading” is a work of excavating and removing earth and sand, or rocks, and loading the removed earth and sand, or rocks onto a loading platform of a transport vehicle such as a dump truck. Dump loading is a unit work including excavation, loaded revolving, unloading, unloaded revolving, waiting for unloading, and loading platform pressing.

“Load collection” is a work of collecting earth and sand produced by excavation or the like before loading the earth and sand on a transport vehicle. Load collection is a unit work including excavation, loaded revolving, unloading, and unloaded revolving, and may include push leveling.

“Traveling” is a work of moving the work machine 100. Traveling as a unit work is a unit work including traveling as an element work.

“Stopping” is a state of stopping for a predetermined time or more without earth and sand, or rocks in the bucket 133. Stopping as a unit work is a unit work including stopping as an element work.

The electric power calculation unit 315 calculates average power consumption and power consumption per unit time for each unit work section based on the time series of measurement data of an electric power sensor acquired by the data acquisition unit 311 and the time series of unit work sections estimated by the estimation unit 314. Specifically, the electric power calculation unit 315 divides the time series of measurement data of the electric power sensor into unit work sections, and obtains power consumption per unit time for each section by dividing the sum of power consumption indicated by the measurement data by the time related to each section.

The electric power calculation unit 315 calculates charging power per unit time based on the time series of measurement data of the electric power sensor acquired by the data acquisition unit 311 and the time series of unit work sections estimated by the estimation unit 314. Specifically, the electric power calculation unit 315 can obtain the charging power per unit time by dividing the sum of charging power indicated by the measurement data when the battery 121 is being charged, among the measurement data of the electric power sensor, by a charging time.

The time calculation unit 316 calculates a remaining operating time by dividing the remaining level of the battery 121 acquired by the data acquisition unit 311 by the power consumption per unit time calculated by the electric power calculation unit 315. The time calculation unit 316 calculates the remaining charging time by dividing a difference between the maximum capacity of the battery 121 and the remaining level of the battery 121 acquired by the data acquisition unit 311 by the charging power per unit time calculated by the electric power calculation unit 315.

The output unit 317 outputs a response message for displaying a display screen of the remaining operating time calculated by the time calculation unit 316.

The warning unit 318 adds warning information to the display screen when the remaining operating time calculated by the time calculation unit 316 is less than a specified time.

### Operation of Display Control System 1

The control device 160 of the work machine 100 transmits measurement data of the sensors and time series data of operation amounts of the operation device 143 to the work analysis device 300 at regular time intervals. The data acquisition unit 311 of the work analysis device 300 records the received time series data in the storage 35 in association with the ID of the work machine 100.

A user such as an operator of the work machine 100, an owner of the work machine, or a person in charge of a construction site accesses the work analysis device 300 using a display device such as a PC or a smartphone in order to grasp the state of the work machine 100. For example, the user accesses the work analysis device 300 by a web browser of the display device. The display device may be the operation terminal 142 of the work machine 100.

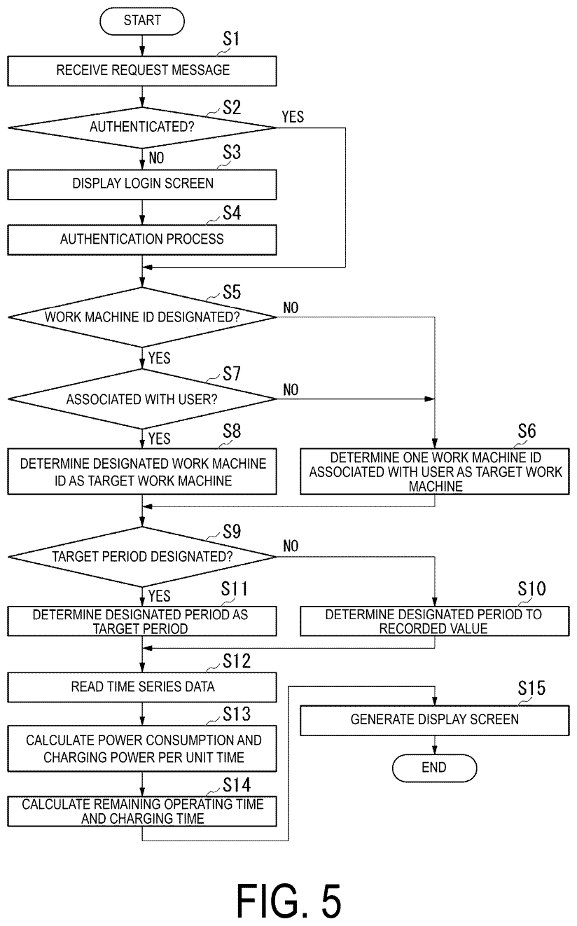

FIG. 5 is a flowchart illustrating a method of presenting a screen by the work analysis device 300 according to the first embodiment. The flowchart illustrated in FIG. 5 is merely an example, and the order and contents of some processes may be different in another embodiment.

When the input unit 312 of the work analysis device 300 receives a request message from the display device (step S1), the authentication unit 313 determines whether the user has been authenticated (step S2). When the user has not been authenticated (step S2: NO), the output unit 317 generates a response message for displaying a login screen for authenticating the user, and outputs the response message to the display device (step S3). The login screen includes input forms for a user ID and a password. The user inputs the user ID and the password on the login screen. The display device transmits a request message having values of the user ID and the password as request parameters.

When the input unit 312 receives the request message, the authentication unit 313 performs an authentication process by collating the user ID and the password related to the response parameter with the data of the account table 353 (step S4).

When the user has been authenticated (step S2: YES), or when the authentication process has been completed in step S4, the work analysis device 300 starts generating a display screen for information regarding the remaining operating time of the work machine 100.

The input unit 312 determines whether a value of a work machine ID for identifying the work machine 100 to be displayed is designated as a request parameter in the request message (step S5).

When the value of the work machine ID has not been designated as the request parameter (step S5: NO), the input unit 312 determines the work machine 100 related to the work machine ID at the top among one or more work machines 100 associated with the authenticated user in the account table 353 as a target work machine (step S6).

When the value of the work machine ID has been designated as the request parameter (step S5: YES), the input unit 312 determines whether the value of the work machine ID is associated with the authenticated user in the account table 353 (step S7). When the value of the work machine ID is associated with the authenticated user in the account table 353 (step S7: YES), the input unit 312 determines the work machine 100 related to the work machine ID as the target work machine (step S8).

When the value of the work machine ID is not associated with the authenticated user in the account table 353, the input unit 312 determines the work machine 100 related to the work machine ID at the top among one or more work machines 100 associated with the authenticated user in the account table 353 as the target work machine (step S6).

The input unit 312 determines whether the request message includes a value of a target period to be analyzed as a request parameter (step S9).

When the value of the target period is not included as the request parameter (step S9: NO), the input unit 312 determines the target period to be a period associated with the authenticated user in the account table 353 (step S10).

When the value of the target period is included as the request parameter (step S9: YES), the input unit 312 determines the target period to be the period designated by the request parameter (step S11). The input unit 312 rewrites the value of the target period associated with the authenticated user in the account table 353 to the value set in the request parameter.

The estimation unit 314 reads, from the state table 352 of the storage 35, the determined work machine ID, and the measurement data and the operation amount of the operation device 143 associated with a time within the target period having the current time as the end point, as time series data (step S12). The estimation unit 314 inputs the read time-series data to the prediction model 351 to generate a time series of work sections of the work machine 100 in the target period.

The electric power calculation unit 315 calculates power consumption and charging power per unit time based on the time series of work sections and the measurement data of the electric power sensor (step S13). Specifically, the power consumption per unit time is calculated by dividing the sum of the measurement data of the electric power sensor in the target period acquired by the data acquisition unit 311 by the length of the target period. In addition, the electric power calculation unit 315 divides the measurement data of the electric power sensor into work sections based on the time series of work sections. The electric power calculation unit 315 calculates, for each work section, the power consumption per unit time for each work section by dividing the sum of the measurement data of the electric power sensor by the length of time related to each work section. Further, the electric power calculation unit 315 calculates the charging power per unit time by dividing the sum of charging power indicated by the measurement data when the battery 121 is being charged, among the measurement data of the electric power sensor, by the charging time.

The time calculation unit 316 calculates a remaining operating time and a remaining charging time based on the power consumption and the charging power per unit time calculated in step S13 (step S14). Specifically, the time calculation unit 316 calculates a remaining operating time in a case of repeating the work in the target period and an operating time in a case of repeating only a work of each section, by dividing the remaining level of the battery 121 acquired by the data acquisition unit 311 by the power consumption per unit time calculated by the electric power calculation unit 315. The time calculation unit 316 calculates the remaining charging time by dividing a difference between the maximum capacity of the battery 121 and the remaining level of the battery 121 acquired by the data acquisition unit 311 by the charging power per unit time calculated by the electric power calculation unit 315.

The output unit 317 generates a display screen that displays the current remaining level of the battery 121, the transition of the remaining level up to the current time, the remaining operating time, and the charging time, and transmits a response message for displaying the display screen (step S15).

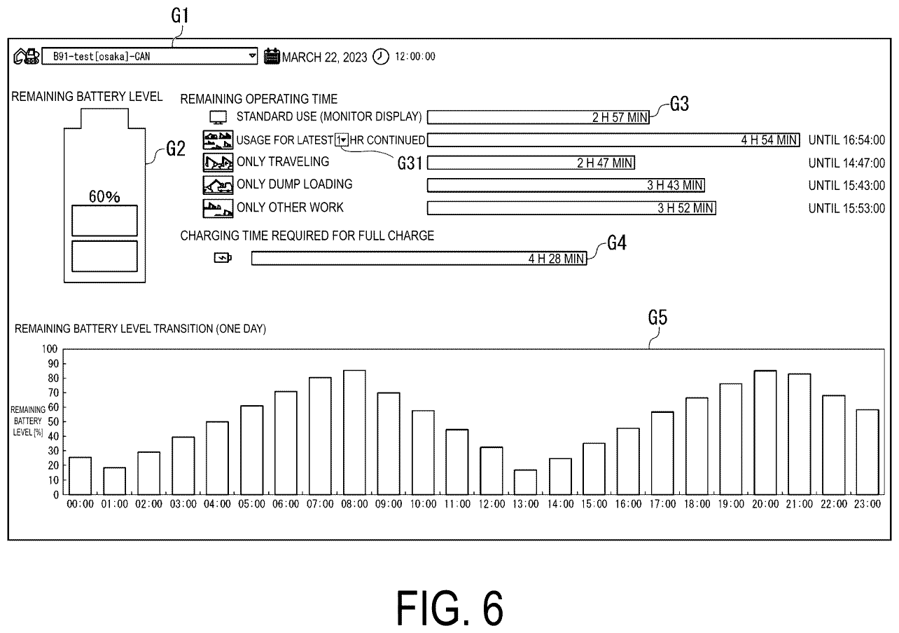

FIG. 6 is a diagram illustrating an example of the display screen according to the first embodiment. The display screen includes a work machine selection form G1, a remaining battery level graph G2, a remaining operating time graph G3, a charging time graph G4, and a remaining battery level transition graph G5.

The work machine selection form G1 receives selection of the work machine 100 associated with the authenticated user. In the display screen, the initial value of the work machine selection form G1 indicates the target work machine determined in step S6 or step S8.

The remaining battery level graph G2 indicates the remaining level of the battery 121 in percentage.

The remaining operating time graph G3 indicates the lengths of a remaining operating time in a case of standard use, a remaining operating time in a case of use for latest N hours, a remaining operating time in a case of only traveling, a remaining operating time in a case of only dump loading, and a remaining operating time in a case of only other works, by bar graphs and numerical values (end timings of operable periods). The remaining operating time in the case of standard use is a remaining operating time calculated based on standard power consumption assumed at the time of designing the work machine 100, without using the data received from the work machine 100. An end timing of an operable period is obtained by adding the remaining operating time to the current time. In the remaining operating time graph G3, “N hours” in the label of the remaining operating time in the case of use for the latest N hours is a list box, and an arbitrary period can be selected. Note that the display screen may display either one of the remaining operating time and the end timing of the operable period.

The charging time graph G4 is a graph in which the length of the charging time is indicated by a bar graph and a numerical value, similarly to the remaining operating time graph G3.

The remaining battery level transition graph G5 is a graph in which the transition of the remaining level of the battery 121 for one day is indicated by a bar graph.

The user can perform an operation in consideration of the remaining operating time of the work machine 100 by visually checking the display screen illustrated in FIG. 6.

The user can display the state of the battery 121 of another work machine 100 by changing the value of the work machine selection form G1 illustrated in FIG. 6 using the display device. When the user changes the value of the work machine selection form G1, the display device returns the processing to step S1, and transmits a request message in which a value of a work machine ID after the change is designated as a request parameter.

The user can change the period for which other power consumption is obtained by changing the value of the target period in the remaining operating time graph G3 illustrated in FIG. 6 using the display device. When the user changes the value of the target period in the remaining operating time graph G3, the display device returns the processing to step S1, and transmits a request message in which a value of a target period after the change is designated as a request parameter. The input unit 312 receives an input of the value of the target period by the request message. That is, the input unit 312 is an example of a period input unit.

Note that the user can transmit a request message for requesting a change of a threshold value used for determination of warning in step S16 to the work analysis device 300 by operating the display device. In this request message, a threshold value after the change is designated as a request parameter. Upon receiving the request message in which the threshold value is designated by the request parameter, the input unit 312 of the work analysis device 300 rewrites the threshold value associated with the user ID of the transmission source of the request message in the account table 353. That is, the input unit 312 is an example of a threshold value input unit.

The warning unit 318 of the work analysis device 300 determines whether a remaining operating time when the work machine 100 is used in a use mode related to a target period recorded in the account table 353 is less than a threshold value recorded in the account table 353 at regular time intervals, separately from the generation of the display screen based on a request from the user illustrated in FIG. 5. When the remaining operating time is less than the threshold value, the warning unit 318 issues a warning of the remaining operating time to the user associated with the threshold value. For example, the warning unit 318 may send an e-mail for warning to a mail address of the user, or may issue a push notification to the display device associated with the user.

### Actions and Effects

As described above, according to the first embodiment, the work analysis device 300 includes the time calculation unit 316 and the output unit 317. The time calculation unit 316 calculates a remaining operating time of the work machine 100 based on a remaining level of the battery 121 and the behavior of the work machine 100 in a predetermined period. The output unit 317 outputs a signal for displaying the remaining operating time. Accordingly, the work analysis device 300 can present the remaining operating time depending on the behavior of the work machine 100. Therefore, the work analysis device 300 can present a highly reliable remaining operating time.

The work analysis device 300 according to the first embodiment further includes the estimation unit 314. The estimation unit 314 estimates a transition of work content of the work machine 100 during a predetermined period based on measurement signals of the work machine 100. The time calculation unit 316 calculates a remaining operating time in a case of continuing a predetermined work content (traveling, dump loading, or the like), based on power consumption related to the predetermined work content. This allows the user to examine a work content that can be performed and a work time until charging. In particular, when the time calculation unit 316 calculates a remaining operating time related to traveling of the work machine 100, the user can consider whether to continue a work from the time required for traveling to a charging station for charging the battery 121.

### Other Embodiments

An embodiment has been described above in detail with reference to the drawings, but a specific configuration is not limited to that described above, and various design changes and the like can be made. That is, in other embodiments, the order of the processing described above may be changed as appropriate. Further, some processing may be executed in parallel. For example, the determination of the target work machine indicated from step S5 to step S8 and the determination of the target period indicated from step S9 to step S11 may be performed in a different order or may be performed at the same time.

The work analysis device 300 according to the above-described embodiment may be constituted by a single computer, or the configuration of the work analysis device 300 may be divided into a plurality of computers, and the plurality of computers may cooperate with each other to function as the work analysis device 300. In that case, some of the computers constituting the work analysis device 300 may be mounted inside the work machine 100 (for example, implemented by the control device 160), and other computers may be provided outside the work machine.

Although the work analysis device 300 according to the above-described embodiment has been described as an example in which the charging time required for the battery 121 to be fully charged is displayed on the display screen, the charging time required for the charge level of the battery 121 to reach a battery charge level designated by the user may be displayed. The battery charge level designated by the user is, for example, a remaining battery level between 70% and 90% with respect to the full charge. In that case, the time calculation unit 316 calculates a remaining charging time by dividing a difference between the battery charge level designated by the user and the remaining level of the battery 121 acquired by the data acquisition unit 311 by a charging power per unit time calculated by the electric power calculation unit 315.

In addition, the work analysis device 300 may display, on the display screen, a remaining operating time or an end timing of an operable period when the remaining battery level is fully charged, together with the charging time graph G4. The work analysis device 300 may display a remaining operating time or an end timing of an operable period when the charge level of the battery 121 reaches a battery charge level designated by the user.

The work analysis device 300 according to the above-described embodiment is a web server, and the display screen is displayed by the display device accessing the work analysis device 300. On the other hand, in another embodiment, the work analysis device 300 may be mounted on the control device 160 or the operation terminal 142 of the work machine 100, and the work analysis device 300 may perform analysis and display control offline.

### REFERENCE SIGNS LIST

1 Display control system; 100 Work machine; 110 Traveling body; 111 Endless track; 112 Travel motor; 120 Revolving body; 121 Battery; 122 Hydraulic pump; 123 Control valve; 124 Revolution motor; 130 Work implement; 131 Boom; 131C Boom cylinder; 132 Arm; 132C Arm cylinder; 133 Bucket; 133C Bucket cylinder; 140 Cab; 141 Operator seat; 142 Operation terminal; 143 Operation device; 143LF left foot pedal; 143LO Left operation lever; 143LT Left travel lever; 143RF Right foot pedal;
143RO Right operation lever; 143RT Right travel lever; 143TB Revolution brake pedal; 160 Control device; 300 Work analysis device; 31 Processor; 311 Data acquisition unit; 312 Input unit; 313 Authentication unit; 314 Estimation unit; 315 Electric power calculation unit; 316 Time calculation unit; 317 Output unit; 318 Warning unit; 33 Main memory; 35 Storage; 351 Prediction model; 352 State table; 353 Account table; 37 Interface; G1 Work machine selection form; G2 Remaining battery level graph; G3 Remaining operating time graph; G4 Charging time graph; G5 Remaining battery level transition graph; T Loading target.

1. A display control system for a work machine driven by a battery, the display control system comprising:
a calculation unit configured to calculate information regarding a remaining operating time of the work machine, based on a remaining level of the battery and a behavior of the work machine in a predetermined period; and
an output unit configured to output a signal for displaying the information regarding the remaining operating time.

2. The display control system according to claim 1, comprising an estimation unit configured to estimate a transition of work content of the work machine in the predetermined period, based on a measurement signal of the work machine,
wherein the calculation unit calculates the information regarding the remaining operating time, based on the estimated transition of the work content.

3. The display control system according to claim 2, wherein
the information regarding the remaining operating time includes a remaining operating time, and
the calculation unit determines power consumption related to predetermined work content, based on the estimated transition of the work content and a transition of power consumption in the predetermined period, and calculates the remaining operating time in a case where the work machine continues the predetermined work content.

4. The display control system according to claim 3, wherein the calculation unit determines power consumption related to traveling of the work machine, based on the estimated transition of the work content and the transition of power consumption in the predetermined period, and calculates the remaining operating time in a case where the work machine continues the traveling.

5. The display control system according to claim 1, wherein the information regarding the remaining operating time includes an end timing of an operable period.

6. The display control system according to claim 1, further comprising a period input unit configured to receive an input of the predetermined period.

7. The display control system according to claim 3, further comprising a warning unit configured to issue a warning when the remaining operating time falls below a threshold value.

8. The display control system according to claim 7, comprising a threshold value input unit configured to receive an input of the threshold value.

9. The display control system according to claim 1, comprising a display device configured to display the information regarding the remaining operating time, based on the signal.

10. The display control system according to claim 2, wherein the information regarding the remaining operating time includes an end timing of an operable period.

11. The display control system according to claim 3, wherein the information regarding the remaining operating time includes an end timing of an operable period.

12. The display control system according to claim 4, wherein the information regarding the remaining operating time includes an end timing of an operable period.

13. The display control system according to claim 2, further comprising a period input unit configured to receive an input of the predetermined period.

14. The display control system according to claim 3, further comprising a period input unit configured to receive an input of the predetermined period.

15. The display control system according to claim 4, further comprising a period input unit configured to receive an input of the predetermined period.

16. The display control system according to claim 4, further comprising a warning unit configured to issue a warning when the remaining operating time falls below a threshold value.

17. The display control system according to claim 16, comprising a threshold value input unit configured to receive an input of the threshold value.

18. The display control system according to claim 2, comprising a display device configured to display the information regarding the remaining operating time, based on the signal.
